(19) United States
(12) Patent Application Publication
(10) Pub. No.: US 2010/0173737 A1
(43) Pub. Date: Jul. 8, 2010

(54) Tool for mounting a belt on a pulley

(75) Inventors: Jean-Philippe Coirault, Tour (FR); Benoit Guillot, Larcay (FR); Dimitri Voulgaris, Nouatre (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hutchinson

(21) Appl. No.: 12/405,697

(22) Filed: Mar. 17, 2009

(30) Foreign Application Priority Data
Jan. 7, 2009 (FR) 0900035

(51) Int. Cl. F16H 7/24

(52) U.S. Cl. 474/130

(57) ABSTRACT

The invention relates to a tool for mounting a belt in a ribbed groove of a pulley of a transmission system, the tool being characterized in that it presents a nose region (10) presenting a catching edge (11) that acts during mounting to form a bearing surface for at least a fraction of the ribs of the belt by raising the outside flank of the belt relative to its opposite inside flank.

The present invention relates to a tool for mounting a belt on a pulley forming part of a transmission system, e.g. a car accessory pulley, or indeed any industrial device requiring mechanical power transmission.

The mounting tool relates more particularly to mounting belts that need to be put under tension while being mounted, e.g. a resilient or “snap-on” belt that is mounted by being snapped on and that can operate without a permanent tensioner since the belt has properties enabling it to maintain sufficient tension while in operation, and to do so over the entire nominal lifetime of the transmission.

Various different types of mounting tool are already known, for example those described in applications EP 0 831 247, FR 2 855 777, or indeed WO 02/36987.

Those tools share the characteristic of being, in principle, external to the pulley, since they involve either guiding the belt over the ribs of the pulley, in which case the tool also overlaps on either side of the pulley (FR 2 855 777) or else on one side thereof (EP 0 831 247 or WO 02/36987), with a considerable lateral offset. In application EP 0 831 247, the tool comes to bear against the ledges lying on either side of the ribs of the pulley and on the flank of the pulley, and extraction is performed with the help of a lever while holding the belt flat and while making use of guidance by a ramp effect. In application WO 02/36987, the belt lies flat on the tool and it is guided laterally by the tool, thereby likewise requiring the still-free portion of the belt to be spaced apart from the flank of the pulley by forming a helix.

An object of the present invention is to provide a novel design for a mounting tool that may optionally be incorporated in a pulley and that facilitates mounting while being compact.

The invention thus provides a tool for mounting a belt in a ribbed groove of a pulley of a transmission system, the tool being characterized in that it presents a nose region presenting a catching edge that acts during mounting to form a bearing surface for at least a fraction of the ribs of the belt by raising the outside flank of the belt relative to its opposite inside flank. Advantageously, the catching edge is disposed radially (α=0) or forms an angle α relative to a radius of the pulley passing through the base of the catching edge, which angle α is measured in a plane perpendicular to the axis of the pulley and less than or equal to 60°, and more particularly lies in the range 30° to 45°.

During mounting, the belt is entrained by the nose region, which transmits forces to the belt while causing it to tilt because its flank in contact with the nose region is raised relative to its opposite flank, thereby enabling the still-free dropped strand of the belt to escape very close to the flank of the pulley.

The catching edge of the nose region may present a peak that is plane, optionally being provided on either side with upstream and downstream convex edges, or it may present a profile that is convex.

Preferably, the catching edge does not extend beyond a rim of the ribbed groove of the pulley.

The catching edge of the nose region may have a working height H that is not less than the width of the ribbed groove of the pulley; this width is substantially equal to the width of the belt that is fitted to the pulley.

Advantageously, the catching edge of the nose region is extended at its base by a profiled disengagement region dropping from said edge of the ribbed groove of the pulley.

Under such circumstances, and advantageously, the catching edge of the nose region and the disengagement region have a working length H′ not less than the width L of the ribbed groove of the pulley.

Advantageously, the profiled disengagement region presents a substantially plane or convex region forming an angle β₁ with a radius of the pulley in a first plane containing said radius and the axis of the pulley, which angle β₁ lies in particular in the range 30° to 60°.

The disengagement region may present at least an upstream and/or downstream edge that is convex.

Preferably, the nose region and the profiled disengagement region present a connection region that is substantially plane, concave, or convex.

Advantageously, the tool upstream from the catching edge, presents a straight or inclined low guide wall running along a portion of said edge of the ribbed groove of the pulley. The nose region may include said low guide wall.

Advantageously, the profiled disengagement region presents a lateral abutment at a free end for coming into contact with an outside flank of the belt during mounting so as to prevent it from slipping.

The tool may be distinct from the pulley, in which case it has a lateral face for bearing against the lateral cheek of the pulley. It may also have a region that presents a bottom face for bearing against the groove of the pulley and a top face against which the belt bears at least at the catching edge and possibly also upstream and/or downstream therefrom. The bottom bearing bottom face preferably presents a profile that is complementary to the ribbed groove of said pulley.

Preferably, the tool is incorporated in said pulley.

The tool may then be characterized in that it is incorporated in a pulley that presents an offset lateral region of smaller area than said lateral region of the pulley and that is inscribed within the outline thereof, and in that said offset lateral region presents a raised outer edge that enables a dropped strand of the belt to be received downstream from the nose region.

The tool may be characterized in that it is incorporated in said pulley, and in that the pulley presents an offset lateral region, in particular a cylindrical region, of area that is smaller than the area of said lateral edge of the pulley and that is inscribed within its outline, and that it includes a first element forming a low guide wall running along a fraction of said edge of the ribbed groove of the pulley and a second element forming a said catching edge and a said profiled disengagement region, at least the second element being carried by said offset lateral region and having a lateral guide zone running beside it.

Under such circumstances, it may be characterized in that the disengagement region presents an upstream first region that is radially substantially level with the ribbed groove of the pulley, and an intermediate second region connecting the upstream region to the offset lateral region.

The invention can be better understood on reading the following description with reference to the accompanying drawings, in which:

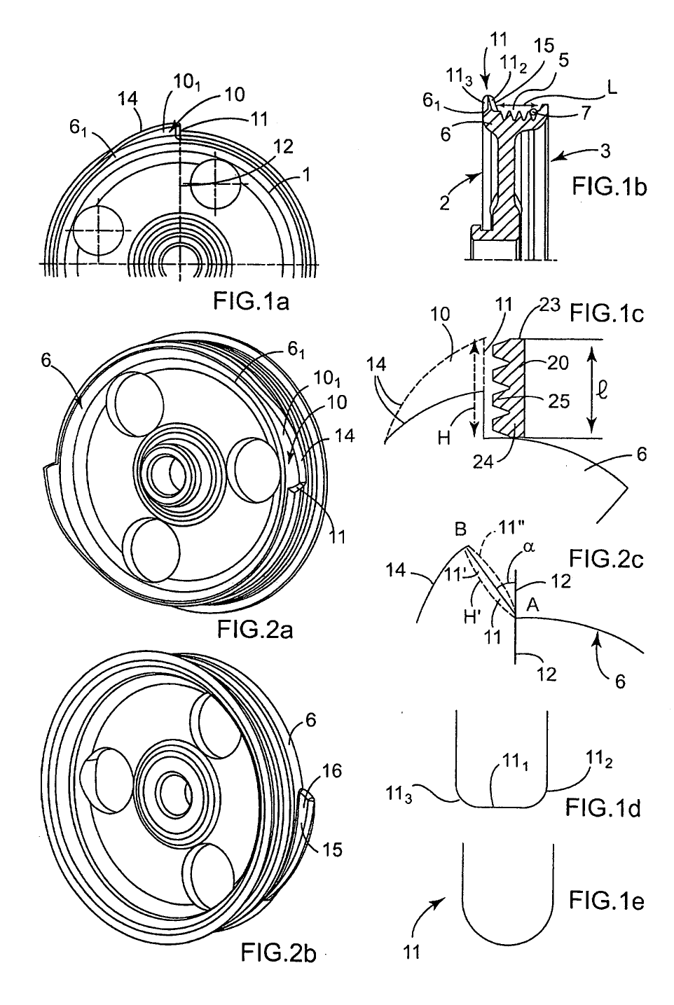

FIGS. 1a & 1b are fragmentary face and profile views of an embodiment of a tool incorporated in a pulley and presenting a nose region, FIG. 1c showing in section the positioning of a belt while it is being mounted, and FIGS. 1d and 1e constituting two median sections showing two shapes for the catching edges;

FIGS. 2a & 2b are two perspective views of another embodiment of an incorporated tool presenting a nose region, and FIG. 2c shows how the angle α is defined;

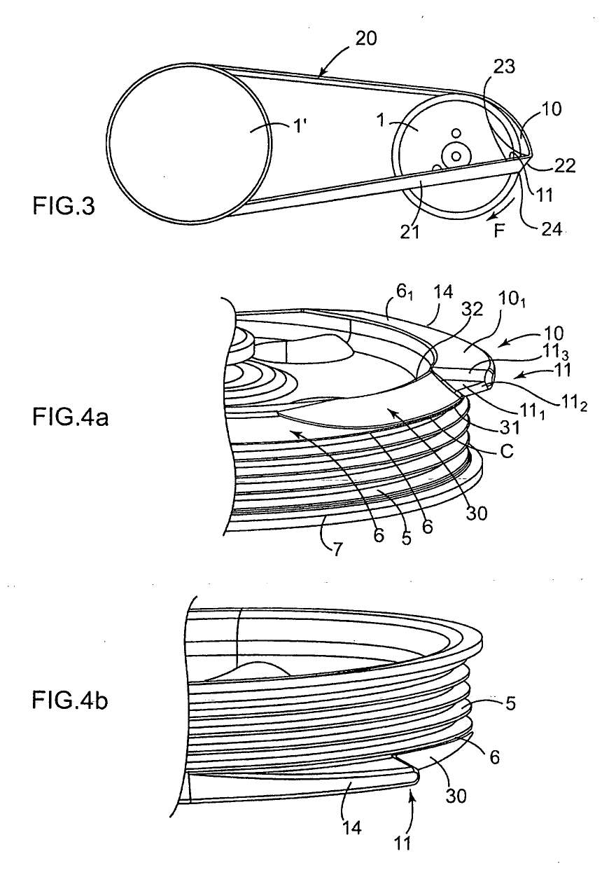

FIG. 3 shows a belt of the invention being mounted on a simplified transmission comprising two pulleys;

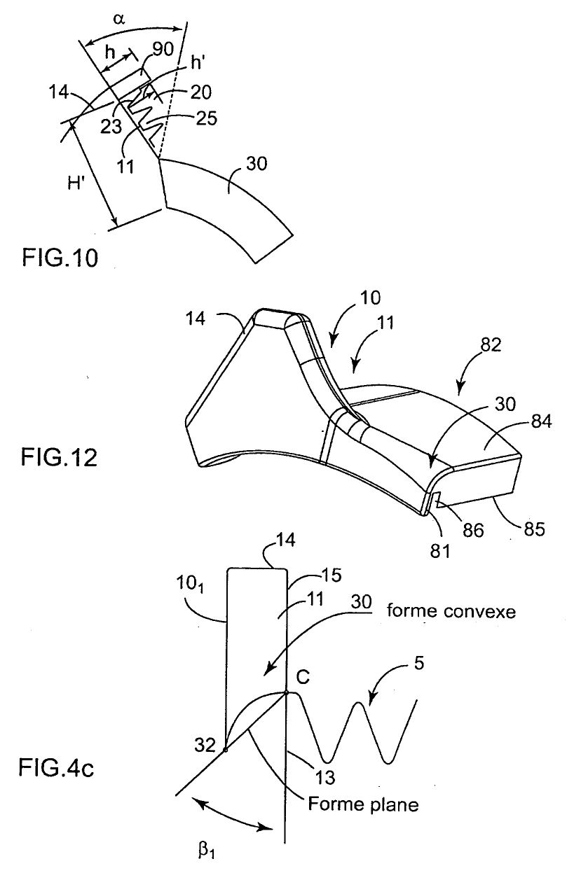

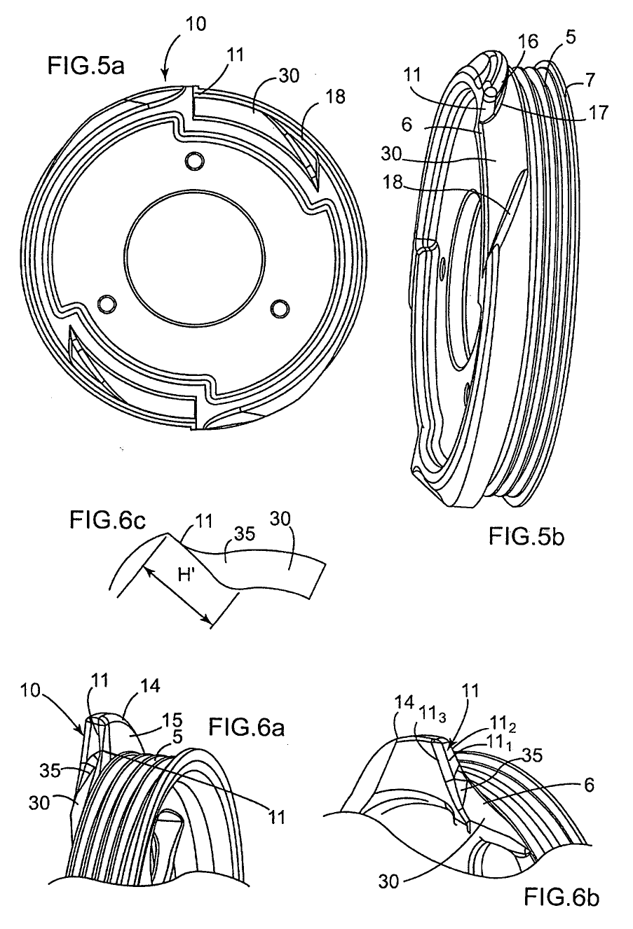

FIGS. 4a & 4b are two perspective views of an embodiment of the invention associating a nose region and a disengagement region, with three variants thereof being shown in perspective in FIGS. 5a & 5b, 6a & 6b, and 7a & 7b, while FIG. 4c shows how the angle β₁ is defined, and FIGS. 6c, 7c, and 8c show how the height H′ is defined respectively for FIGS. 6a & 6b, 7a & 7b, and 8a & 8b;

FIGS. 8a & 8b, and FIGS. 9a & 9b are perspective and profile views of two variants of the invention adapted to a pulley that presents an offset region of area smaller than the area of the pulley cheek;

FIG. 10 shows a variant of the invention in which the catching edge of the nose region presents an anti-slip side abutment; and

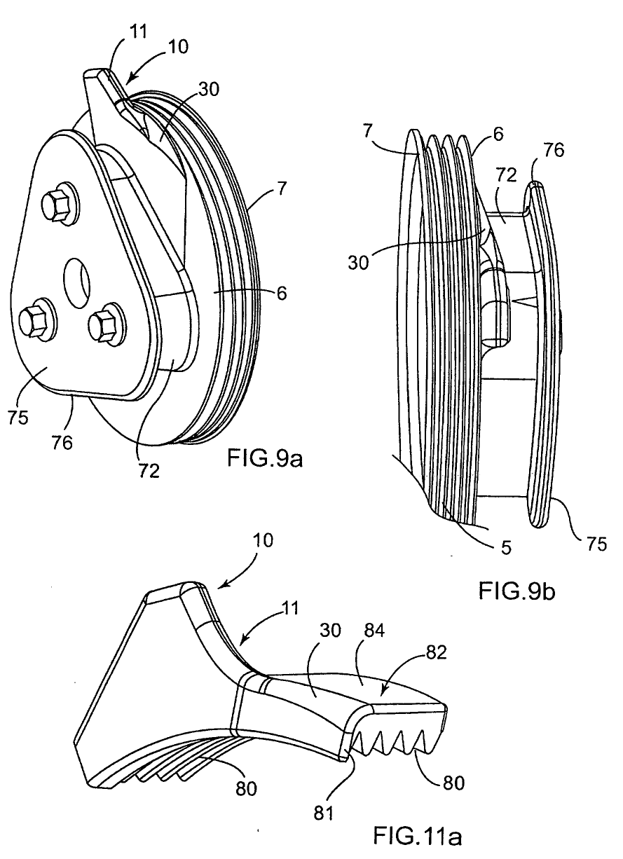

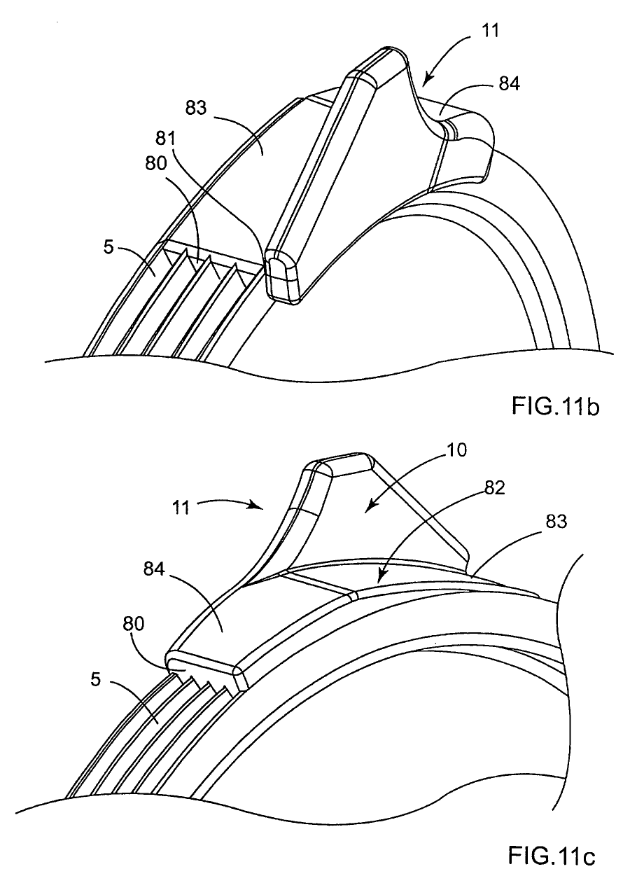

FIGS. 11a to 11c are perspective views of a preferred variant of a separate tool adapted to be mounted on the pulley (FIG. 11a), FIGS. 11b and 11c being two perspective views of the tool installed on a pulley, and FIG. 12 showing a simplified variant.

FIG. 1a shows a pulley 1 having two cheeks or flanks 2 and 3, a central axis 4, and a ribbed groove 5 of width L suitable for receiving the ribs of a belt, e.g. a K-type car transmission belt.

The ribbed groove 5 lies between two rims 6 and 7, one of which rims, 6, presents a noose region 10 presenting a catching edge 11 disposed to form a radial catching zone (FIGS. 1a and 1b) that present a peak region 111 situated in a plane containing the radius 12 and the axis of the pulley 1 and that lies between upstream and downstream regions 11₂ and 11₃ of rounded shape, or else that presents a radially-oriented convex profile (FIG. 1e), i.e. having a surface with generator lines that are parallel to the radius 12 and that pass through the peak of the catching zone 11 (FIG. 1a) or that present generator lines that are concave or convex. In FIG. 1b, it can be seen that the catching edge 11 does not extend beyond the rim 6. In the example, its outside face 10₁ terminates in register with the outside face 6₁ of the rim 6.

It should be observed that in general, it is appropriate to avoid the ribs 25 and the flanks 23, 24 of the belt 20 encountering sharp edges on their path, and it is therefore desirable to make the outlines rounded.

The catching edge 11 presents a height H (FIG. 1c) that is preferably equal to the width L of the ribbed groove 5 (which is substantially equal to the width l of the belt), thus making it possible to present a sufficient working bearing length (dashed line 14) for receiving the ribs 25 of the belt 20 by lifting the outside flank 23 relative to the inside flank 24.

In practice, and given its position, the catching edge 11 prevents the belt 20 from shifting sideways.

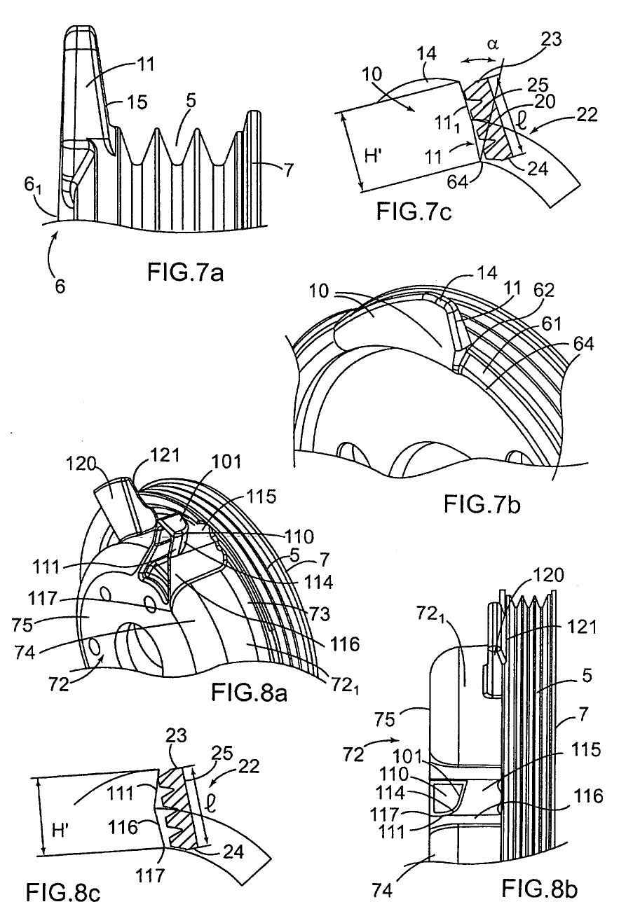

Nevertheless, upstream from the catching edge 11, it is advantageous for the nose region 10 to present a straight or sloping plane flank 15 (see also FIGS. 6a and 7a) running along the rim 6 so that while mounting the belt 20 it constitutes a low lateral guide wall for the belt 20 being fitted in the groove 5.

Towards the rear, the top face of the nose region 10 may present towards the rear a progressive profile 14 that joins the rim 6. This progressive profile provides good mechanical strength while avoiding too much weight for the nose region 10, and thus avoiding too much unbalance generated thereby.

FIGS. 2a and 2b show a variant in which the catching zone 11 is no longer radial, but rather is inclined relative to the radius 12 by an angle α in a plane that contains the radius 12 (which in this case passes through the base of the catching edge 11) and that is perpendicular to the axis of the pulley. This angle α is generally specified to have a value of less than 80°, and in particular of less than 60°, it preferably lies in the range 30° to 45°, and it is shown in FIG. 2c, as is the working height H′. Preferably, H′≧L. For a shape that is concave or convex (dashed generator lines 11′ or 11″), the angle α is defined between the end points A and B at the base and at the peak of the catching edge 11. It should be observed that a concave or convex shape as shown is favorable from the point of view of the belt slipping outwards along the edge 11 under the effect of tension. The plane flank 15 may lead to the catching edge 11 via a region 16 (FIG. 2b) that faces outwards and that enables the belt to be properly guided.

FIG. 3 shows a belt 20 being mounted on a simplified transmission system given by way of example, comprising only two pulleys 1 and 1′. The belt is fitted onto the pulley 1′ and it is pre-positioned on the ribbed groove 5 and on the catching edge 11 so as to present downstream (in the fitting direction) a dropped strand 21 that runs over the cheek 2 of the pulley 1.

By causing the pulley 1 to turn in the direction of direction F, the belt 20 is fitted progressively into the groove 5 of the pulley since the belt 20, which has its outside flank 23 raised relative to its inside flank 24, is pushed by the catching edge 11 that comes into contact with at least some of the ribs 25 in the zone 22 of the belt 20. By continuing to turn the pulley 1 in the direction of arrow F, the belt 20 is fitted into the groove 5 of the pulley 1, while being put progressively under tension.

In order to make it easier to position the dropped strand 21 that is obtained by the belt twisting around the catching edge 11, it is advantageous to provide a profiled disengagement region 30 downstream from the catching edge 11 of the nose region 10, which profiled disengagement region 30 drops away from the raised rim 6 of the groove 5. This disengagement region 30 may be plane as shown in FIGS. 4a and 4b, forming an angle β₁ relative to a radius 13 that passes through the center C of its upstream curvilinear outline 31 (reference 32 designating its downstream curvilinear outline), which angle β₁ lies for example in the range 30° to 60°. An angle β₁ equal to 90° would correspond to a non-sloping shape, whereas an angle of zero would correspond to a vertical disengagement shape. This angle β₁ is measured in a plane that contains the radius 13 and the axis of the pulley 1 and it is measured positively going outwards (FIG. 4c). For a plane disengagement region 30, the angle is measured between the segment (32, C) and the radius 13.

The disengagement region 30 may be convex, with β₁ then being determined as shown in FIG. 4c, likewise as being the angle between the radius 13 and the segment (32, C).

The disengagement region 30 may present an upstream edge 31 and/or a downstream edge 32 that is/are convex.

As explained below, the presence of the region 30 makes it possible to lengthen the useful bearing region of the ribs of the belt 20 in the region 22 (thereby making it possible to reduce the height of the nose region 10), and the working contact length H′ may advantageously be selected to be greater than or equal to the width of the groove 5. It should be observed that in this example (FIG. 4a), α=0°, however some other specified value for the angle α could be implemented.

FIGS. 5a and 5b show a nose region 10 that presents an outwardly-directed convex outline 16 upstream from the catching edge 11 and beside the disengagement region 30 so as to improve guidance of the dropped strand 21 of the belt 20 around the catching edge 11, which in this example is of rounded shape. An outwardly-sloping low guide wall 18 may also be provided at a sufficient distance from the catching edge 11 for the purpose of accompanying the movement of the belt 20. In this example it should be observed that α=0°, however it could be implemented with any other specified value for the angle α.

Since turning the pulley 1 in the direction of arrow F presses the zone 22 of the belt against the catching edge 11, the low guide wall 18 in practice performs an auxiliary function only.

In the preferred variant of FIGS. 6a and 6b, there exists a plane, concave, or convex transition region 35 between the catching edge 11 and the profiled disengagement region 30, thereby enabling the belt to be guided progressively. In this variant, the catching edge 11 is inclined at a non-zero angle α of less than 60° that preferably lies in the range 30° to 45°. The working length H′ (preferably H′≧L) is shown in FIG. 6c. It can be seen that it covers the peak region 11 and the transition region 35.

FIGS. 7a and 7b show another variant in which the pulley 1 presents a frustoconical dropped edge 61 that connects with the catching edge 11 via a concave connection zone 63 (0≦α<60° and a preferably in the range 30° to 45°). The working length H′ covers the peak 11₁ of the catching edge 11 and the connection zone 62 as far as the end 64 of the frustoconical edge 61 (see FIG. 7c), and the working length H′ is preferably greater than or equal to the width l of the belt 20.

FIGS. 8a and 8b show a tool incorporated in a pulley that presents an offset region 72 of area smaller than the area of the side edge of the pulley, and in particular of intermediate diameter less than the diameter of the groove 5 of the pulley 1.

The nose region 110 is a separate element that presents a J-shaped profile with a substantially plane upstream region 101 that guides the belt 20 outwards downstream from the inside flank 121 of a low guide wall 120 adjacent and overlying the groove 5 of the pulley 1.

During mounting, the outside flank 23 of the belt 20 runs along the inside edge 121 and the region 101 situated in the continuation thereof, and it turns downstream in the circularly-arcuate region 114 to reach the catching edge 111. The belt 20 bears against the plane or convex region 115 adjacent to the upstream region 101 and situated radially substantially level with the ribbed groove 5. The belt is then guided by the plane or convex intermediate region 116 and slips along the rounded portion 74 that is optionally presented by the cylindrical region 72₁ situated between the ledge 73 and the flank 75 of the intermediate region 72.

The circularly-arcuate region 114 connecting the region 101 to the catching zone 111 enables rotation of the belt 20 to be accompanied during mounting that is performed in the manner shown in FIG. 3.

The working length H′ should be taken into account (and preferably not less than l) covers the catching edge 111 and the region 116 as far as the foot 117 thereof. This serves to reduce the effective height of the nose region 110. In the example shown, α=0, but this angle could present a non-zero value less than 60°, and preferably lying in the range 30° to 45°.

In the embodiment shown, there are two distinct elements 110 and 120, each in the continuation of the other, however they could be united so as to form a single element, but that solution would increase weight and unbalance without presenting any particular functional advantage.

FIGS. 9a and 9b show another embodiment for a pulley having an offset region.

The tool presents a nose region 10 and possibly also a disengagement region 30 as shown in FIGS. 1a, 1b; 2a, 2b; 4a, 4b; 5a, 5b; 6a, 6b; or 7a, 7b, and the offset region 72 presents a low wall 76 that extends the flank 75 and that enables the belt to be held on the outline of the region 72 against the main cheek 6 of the pulley.

It should be observed that the offset region 72 may be of triangular shape, as shown, having alternating straight regions and rounded regions, or else it could have some other outline, e.g. it could be cylindrical as shown in FIGS. 8a and 8b.

The above-described tools are incorporated in the corresponding pulleys. By their very design, they give rise to weight that is off-center and they thus give rise to unbalance. Certain variants enable the height of the nose region to be decreased, thereby decreasing the unbalance. The unbalance may be compensated by flyweights and/or by providing localized openings, or indeed by having two tools disposed symmetrically as in FIGS. 2a & 2b or 5a & 5b.

It is particularly advantageous to incorporate such a tool in a pulley of thermosetting material, which is much lighter in weight than a metal pulley. Under such circumstances, the unbalance due to the tool can usually be considered as being negligible, and therefore does not need to be compensated.

The value of the angle α is limited by the outward slipping of the belt along the edge 11 under the effect of tension. This slipping increases with increasing belt mounting tension. It is therefore much greater for a K-type car belt than for a domestic appliance belt (washing machine), for example. The value of the angle α can be increased by placing an abutment 90 at the top end of the catching edge 11 (see FIG. 10), which abutment 90 is of height h (e.g. h=h₀, where h₀ is the height of the belt 20), thereby holding the outside flank 23 of the belt 20.

FIGS. 11a to 11c relate to a tool, e.g. made of plastics material or of metal, that can be independent from the pulley. This tool may include a nose region 10 and possibly also a disengagement region 30 as described with reference to FIGS. 1a, 1b; 2a, 2b; 4a, 4b; 5a, 5b; 6a, 6b; or 7a, 7b. It is mounted on the groove 5 of the pulley 1 by a ribbed profile 80 that is complementary to the ribbed profile of the groove 5 and by an edge 81 that bears against the cheek 6 of the pulley 1, preferably on the edge that carries the nose region 10. The edge 81 serves to prevent the tool from tilting over during mounting.

During mounting, the belt is put progressively under tension and it bears against the top face 82 that receives the ribs of the belt, thereby holding the tool in place. Mounting takes place as shown in FIG. 3, after which the tool can be removed.

The bearing top face 82 of the belt advantageously presents a profile that extends from an upstream edge 83 housing the nose region 10, and this profile is located at least in register with the catching edge 11, and an edge 84 that extends beyond the foot of the catching edge 11 over a length that is sufficient to provide a bearing point for the belt 20 during its twisting movement around the catching edge 11.

The profile of the top face 82 is advantageously progressive from the upstream edge 83 situated practically level with the ribs of the groove 5 in the pulley 1, and the downstream edge 84 which is raised to provide sufficient thickness to enable the tool to have the strength to withstand mounting forces.

FIG. 12 shows a simplified variant of FIGS. 11a to 11c that differs by the absence of the ribbed profile 80, which profile is replaced by a concave bearing face 85 that bears against the ribbed groove 5 of the pulley. The concave bearing face 85 has a groove 86 running along the side thereof to define the edge 81 that comes to bear against the cheek 6 of the pulley 1. The edge 81 and the groove 86 serve to prevent the tool tilting over during mounting.

1. A tool for mounting a belt in a ribbed groove of a pulley of a transmission system, the tool being characterized in that it presents a nose region presenting a catching edge that acts during mounting to form a bearing surface for at least a fraction of the ribs of the belt by raising the outside flank of the belt relative to its opposite inside flank.

2. A tool according to claim 1, characterized in that the catching edge is disposed radially or forms an angle α relative to a radius of the pulley passing through a base of the catching edge, which angle α is measured in a plane perpendicular to the axis of the pulley and is less than 80°.

3. A tool according to claim 1, characterized in that the catching edge of the nose region presents a peak that is flat.

4. A tool according to claim 3, characterized in that the peak region of the catching edge presents convex edges on either side.

5. A tool according to claim 1, characterized in that the catching edge is convex.

6. A tool according to claim 1, characterized in that the catching edge of the nose region has a working height H that is not less than the width of the ribbed groove of the pulley.

7. A tool according to claim 1, characterized in that the catching edge of the nose region is extended at its base by a profiled disengagement region dropping from said edge of the ribbed groove of the pulley.

8. A tool according to claim 6, characterized in that the catching edge of the nose region and the disengagement region have a working length H′ not less than the width of the ribbed groove of the pulley.

9. A tool according to claim 7, characterized in that the profiled disengagement region presents a substantially plane or convex region forming an angle β₁ with a radius of the pulley in a first plane containing said radius and the axis of the pulley, which angle β₁ lies in particular in the range 30° to 60°.

10. A tool according to claim 7 characterized in that the disengagement region presents at least an upstream and/or downstream edge that is convex.

11. A tool according to claim 7, characterized in that the nose region and the profiled disengagement region present a connection region that is substantially plane, concave, or convex.

12. A tool according to claim 1, characterized in that, upstream from the catching edge, it presents a straight or inclined low guide wall running along a portion of said edge of the ribbed groove of the pulley.

13. A tool according to claim 12, characterized in that the nose region includes said low guide wall.

14. A tool according to claim 1, characterized in that the profiled disengagement region presents a lateral abutment at a free end for coming into contact with an outside flank of the belt during mounting so as to prevent it from slipping.

15. A tool according to claim 1, characterized in that the tool is distinct from the pulley and has a lateral face for bearing against a lateral cheek of the pulley and a region presenting a bottom face for bearing against the groove of the pulley and a top face against which the belt bears and that is placed at least at the catching edge.

16. A tool according to claim 15, characterized in that said bearing bottom face presents a profile that is complementary to the ribbed groove of said pulley.

17. A tool according to claim 1, characterized in that it is incorporated in said pulley.

18. A tool according to claim 1, characterized in that it is incorporated in a pulley that presents an offset lateral region of smaller area than said lateral region of the pulley and that is inscribed within the outline thereof, and in that said offset lateral region presents a raised outer edge that enables a dropped strand of the belt to be received downstream from the nose region.

19. A tool according to claim 1, characterized in that it is incorporated in said pulley, and in that the pulley presents an offset lateral region, in particular a cylindrical region, of area that is smaller than the area of said lateral edge of the pulley and that is inscribed within its outline, and that it includes a first element forming a low guide wall running along a fraction of said edge of the ribbed groove of the pulley and a second element forming a said catching edge and a said profiled disengagement region, at least the second element being carried by said offset lateral region and having a lateral guide zone running beside it.

20. A tool according to claim 19, characterized in that the disengagement region presents an upstream first region that is radially substantially level with the ribbed groove of the pulley, and an intermediate second region connecting the upstream region to the offset lateral region.
